(19) United States
(12) Patent Application Publication
(10) Pub. No.: US 2008/0049024 A1
(43) Pub. Date: Feb. 28, 2008

(54) Method and Apparatus to Generate Borders That Change With Time

(76) Inventors: Barinder Singh Rai, Surrey (CA); Eric Jeffrey, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/467,109

(22) Filed: Aug. 24, 2006

(51) Int. Cl. G06T 13/00

(52) U.S. Cl. 345/473

(57) ABSTRACT

A method and apparatus for changing over time the appearance of a border around a displayed image. A graphics controller includes a number of border address registers and border changing parameter registers that are written into from a host device. In response to an activation signal from the host device and a timing signal, such as a vertical synchronization signal from a display device, a border changing circuit of the graphics controller changes the appearance of the border over time without further intervention from the host device.

### BACKGROUND OF THE INVENTION

1. Field of the Invention

This invention relates generally to computer systems and more particularly to a method and apparatus for generating a border for a displayed image, especially on a display device forming part of a hand-held unit.

2. Description of the Related Art

Liquid crystal display (LCD) controller designs typically provide some capability of adding a border to a displayed image. Typically, the border has a simple rectangular shape that frames the main image. However, the border can take irregular shapes as well. Typically, in order to change the appearance of the border, a host device (e.g. CPU) must write new pixel data into the particular memory locations corresponding to the border in the LCD controller. If it is desired to change the border over time, the host device must monitor the display refresh cycles and write new border pixel data after each one or more refresh cycles. This burdens the host device and may slow overall operation of the device.

As a result, there is a need to solve the problems of the prior art to provide a border generation scheme that reduces the burden on the host device without limiting the border options available to a user.

### SUMMARY OF THE INVENTION

Broadly speaking, the present invention fills these needs by providing a graphics controller that includes a number of border address registers and border changing parameter registers that are written into from a host device. In response to an activation signal from the host device and a timing signal from a display device, a border changing circuit of the graphics controller changes the appearance of the border over time without further intervention from the host device.

It should be appreciated that the present invention can be implemented in numerous ways, including as a process, a system, or a device. Several inventive embodiments of the present invention are described below.

In one embodiment, a border changing parameter is an incremental amount of change parameter and the border changing circuit is responsive to the incremental amount of change parameter for changing the appearance of the border by an amount specified by the incremental amount of change parameter. For example, the incremental amount of change parameter could specify a change in color value and the border will change color by an incremental amount with each occurrence of the timing signal.

In another embodiment, a border changing parameter is a frequency of change parameter and the border changing circuit is responsive to the incremental amount of change parameter and frequency of change parameter for changing the appearance of the border by an amount specified by the incremental amount of change parameter after a number of occurrences of the timing signal as specified by frequency of change parameter.

In an embodiment, the timing signal is a display synchronization signal, e.g. Vsync, received from the display device. In this way the graphics controller monitors the refresh cycles of the display and changes the appearance of the border in synchronization therewith. In another embodiment, the timing signal is generated internally in the graphics controller by a time generator, e.g. a crystal oscillator.

In a further embodiment an event signal generator is provided and the border changing circuit is responsive to the generation of the event signal for changing the appearance of the border. For example, a battery monitoring circuit is provided to monitor the state or condition of a battery and generate an event signal such as BATTlow whenever the voltage of battery falls below a certain threshold level. In response to reception of this signal, the border color changing circuit will begin changing the color. In this embodiment, the start border color could be black and end border color red.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is an illustration showing a high-level architecture of a device for displaying graphical information in accordance with an embodiment of the invention, and FIG. 1A illustrates the device using a RAM-integrated display.

FIG. 2 shows an exemplary display in accordance with an embodiment of the invention.

FIG. 3 is a schematic block diagram of a graphics controller in accordance with an embodiment of the invention.

FIG. 4 illustrates the a memory portion of the display buffer with particular memory locations assigned to the main image and particular locations assigned to the border in accordance with an embodiment of the invention.

FIG. 5 illustrates exemplary registers in a register set in accordance with an embodiment of the invention.

FIG. 6 is a flow chart illustrating exemplary operations performed by a border changing circuit in accordance with an embodiment of the invention.

FIG. 7 is a flow chart illustrating a border changing operation of the border changing circuit in accordance with an embodiment of the invention.

FIG. 8 is a flow chart illustrating an alternate operational flow of the operations shown in FIG. 6.

FIG. 9 illustrates a portion of a two color border that changes appearance over time in accordance with an embodiment of the invention.

FIG. 10 illustrates exemplary shapes for borders in accordance with an embodiment of the invention.

FIG. 11 illustrates a border in which the general shape remains the same but the border image is varied over time by shifting the shape relative to the main image to give the appearance of the border moving clockwise around the main image in accordance with an embodiment of the invention.

### DETAILED DESCRIPTION OF THE PREFERRED EMBODIMENTS

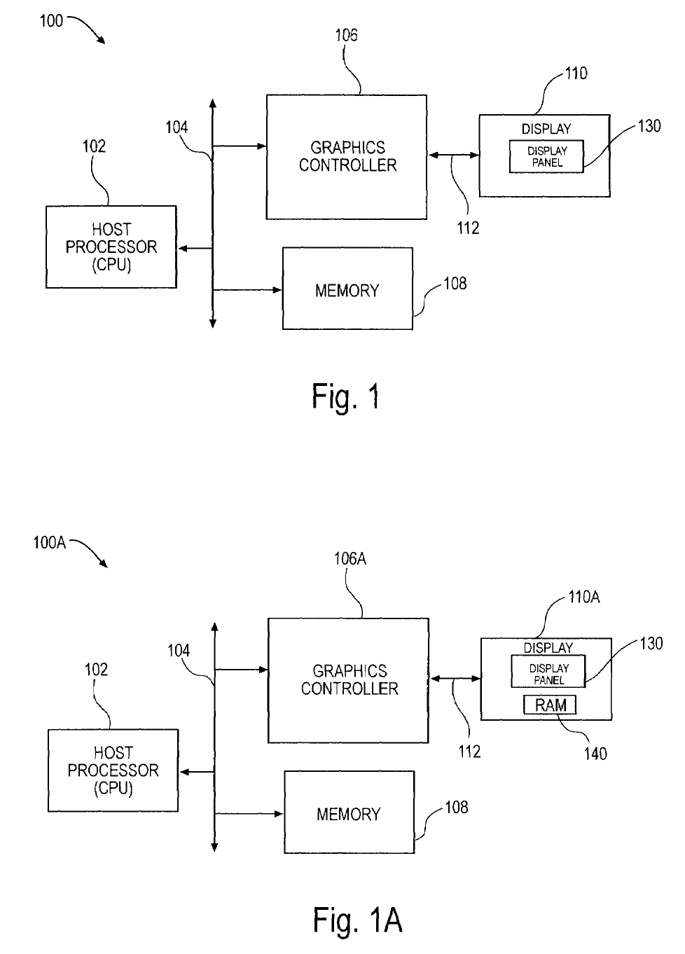

FIG. 1 is an illustration showing a high-level architecture of a device 100 for displaying graphical information. The device includes a host processor (CPU) 102 in communication with a graphics controller 106 and memory 108 over a bus 104. The graphics controller 106 provides an interface between host processor 102 and display 110.

The timing control signals and data lines between graphics controller 106 and display 110 are shown generally as line 112. These may in fact be several separate address, data and control lines but are shown generally as line112, which may be referred to as a bus. It should be recognized that such address and data pathways may be represented throughout the figures as a single line. Host processor 102 performs digital processing operations and communicates with graphics controller 106 and memory 108 over bus 104. In other embodiments, processor 102 communicates over several address, data, and control lines.

In addition to the components mentioned above and illustrated in FIG. 1, those skilled in the art will recognize that there may be many other components incorporated into device 100, consistent with the particular application of the present invention. For example, if device 100 is a cell phone, then a wireless network interface, random access memory (RAM), digital-to-analog and analog-to-digital converters, amplifiers, keypad input, and so forth will be provided. Likewise, if device 100 is a personal data assistant (PDA), various hardware consistent with providing a PDA will be included in device 100. It will therefore be understood that FIG. 1 is not intended to be limiting, but rather to provide a basic block diagram of the present invention.

Host processor 102 performs digital processing operations and communicates with graphics controller 106. In one embodiment, processor comprises an integrated circuit capable of executing instructions retrieved from memory 108. These instructions provide device 100 with functionality when executed by processor 102. Processor 102 may also be a digital signal processor (DSP) or other processing device. Examples include the Motorola Dragonball series of processors and similar deices made by Intel, Hitachi, NEC, etc.

Memory 108 may be internal or external random-access memory or non-volatile memory. Memory 108 may be non-removable memory such as flash memory or other EEPROM, or magnetic media. Alternatively, memory 108 may take the form of a removable memory card such as ones widely available and sold under such trademarks as “SD Card,” “Compact Flash,” and “Memory Stick.” Memory 108 may also be any other type of machine-readable removable or non-removable media. Memory 108 may be remote from device 100. For example, memory 108 may be connected to device 100 via a communications port (not shown), where a BLUETOOTH® interface or an IEEE 802.11 interface, commonly referred to as “Wi-Fi,” is included. Such an interface may connect device 100 with a remote host (not shown) for transmitting data to and from the remote host. If device 100 is a communications device such as a cell phone, it may include a wireless communications link to a carrier, which may then store data in hard drives as a service to customers, or transmit data to another cell phone or email address. Memory 108 may be a combination of memories. For example, it may include both a removable memory card for storing image data, and a non-removable memory for storing data and software executed by processor 102.

Display 110 can be any form of display capable of displaying a digital image. In one embodiment, display 110 comprises a liquid crystal display (LCD). However, other types of displays are available or may become available that are capable of displaying an image that may be used in conjunction with device 100.

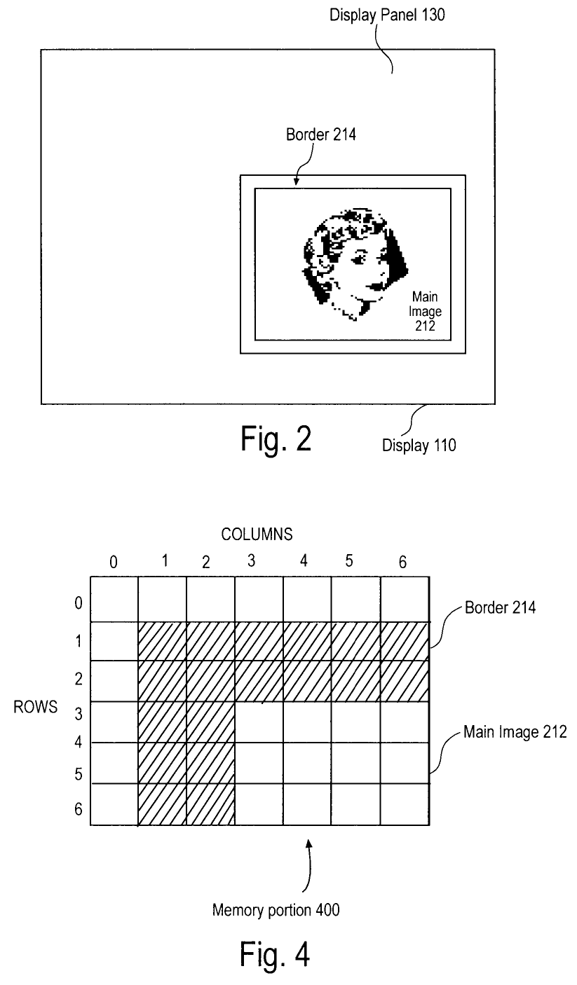

FIG. 2 shows an exemplary display screen 210 displaying a main image 212 surrounded by a border 214. A border is a defined region of the displayed image. Typically, it is a simple rectangular shape that frames the main displayed image. However, it can take any shape.

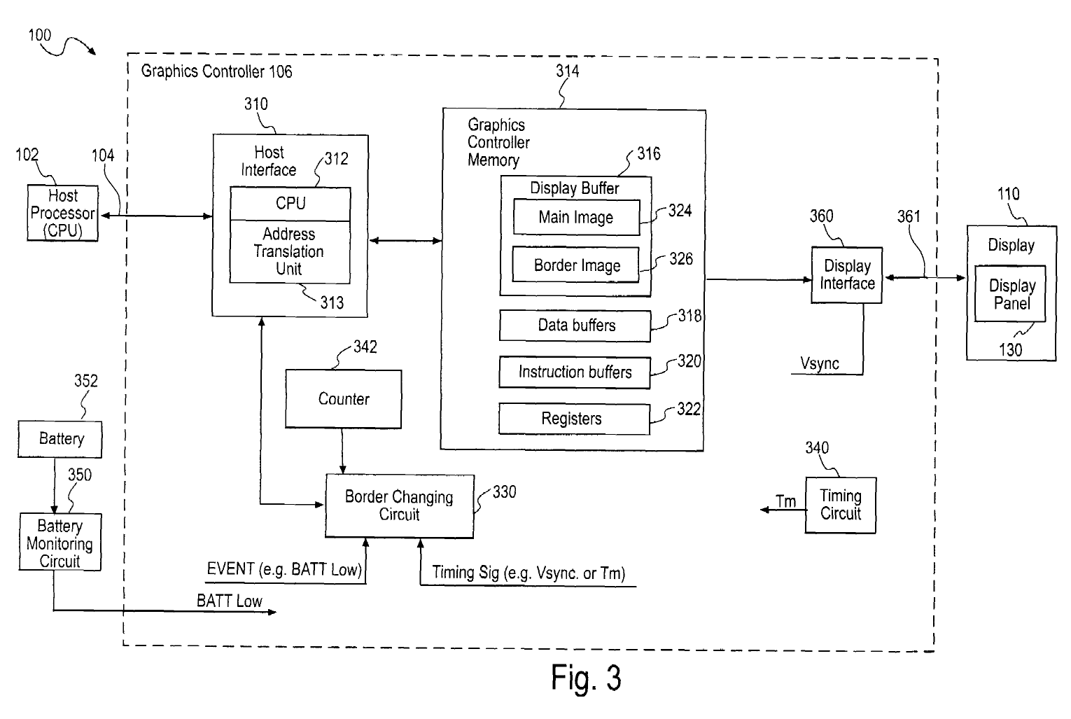

FIG. 3 shows an exemplary embodiment of graphics controller 106, which is preferably an integrated circuit (IC) or forms part of an IC. Graphics controller 106 is an electronic device including logic that may, for example, be implemented in an application-specific integrated circuit (ASIC), a field programmable gate array (FPGA), or otherwise implemented in hardware. Therefore, graphics controller 106 comprises logic formed from logic gates, and may or may not require software instructions to operate.

Host processor 102 is in communication with host interface 310, which receives data, address, and control information over bus 104. The host interface 310 will include, among other things, an embedded CPU 312, along with address translation unit 313, and performs such functions as address translation for reading from and writing to graphics controller memory 314 and data transfer between memory 314 and host processor 102. The address translation unit 313 will translate software addresses received from the host processor (CPU) 102 into physical addresses that identify locations in the graphics controller memory 314.

The display buffer 316 will occupy a portion of the physical memory, i.e. graphics controller memory 314, which may be, for example, a 256K byte SRAM. For example, the display buffer 316 may occupy 128K of the physical memory, with the balance being used as data buffers 318, instruction buffers 320, and/or registers 322. It should be noted that for the sake of discussion, registers 322 are shown as a register block in memory 314, but may in fact be distinct hardware registers that are accessible separately from memory 314.

Display data read from the graphics controller memory 314 is transmitted to the display 110 for display on display panel 130 through display interface 360 via bus or signal lines 361. Additional control and timing signals (e.g. Vsync) are exchanged between display panel 130 and display interface 360 via bus or signal lines 361.

The display buffer may form part of the physical memory embedded in the graphics controller chip as shown in FIG. 3, or the display buffer may be part of the physical memory of a RAM-integrated display. FIG. 1A is an exemplary embodiment of a device 100A having a graphics controller 106A intended for use with a RAM-integrated display 110A. RAM-integrated displays have become more common in battery-operated devices. Ram-integrated display 110A contains, among other things, a physical display RAM 140 incorporated into the display unit itself, along with timer circuitry, driver circuitry and various display registers for controlling how display data, stored in the memory, is presented on the display screen. At least a portion of physical display RAM 140 is assigned to store the display buffer 316 including a border image memory 326 and a main image memory 324. RAM-integrated display 110A contains programmable registers to define where and how the display data is presented. Detailed information regarding RAM-integrated display panels may be found in U.S. Pat. No. 6,937,223, issued on Aug. 30, 2005 to Matsuyama and U.S. Pat. No. 6,943,782 issued on Sep. 13, 2005 to Tamura. Both of these patents are hereby incorporated by reference in their entirety. In this embodiment, the graphics controller 410 can be manufactured with much less embedded memory as compared to the graphics controller 106 shown in FIG. 3.

Each area of the display buffer 316 will have starting addresses that are stored in registers 322. Typically the host processor writes image data into the main image memory 324 of the display buffer and also writes border data into the border image memory 326 of the display buffer. For the sake of discussion it will be assumed that the contents of the display buffer 316 comprising the border image memory 326 and the main image memory 324 map directly into the pixel locations in the display panel. However, it will be appreciated that the display buffer must be organized to meet the particular configuration of the display panel so that the pixel locations in the display buffer correspond to the pixel locations in the panel and the correct data is displayed in the proper location. To this end, the software address of display data received from the host processor 102 must be translated into an appropriate physical address in the display buffer 316. This task is performed by and an address translation unit 313 of the host interface 310 and/or the embedded CPU 312.

Generally speaking, the display buffer is organized as a Cartesian matrix of pixels, with a correspondence between a pixel's position in the display buffer and it's position on the display. This correspondence can be programmed for each particular type of display with address and control registers 322 that identify, for example, the start position of the border and increment values which advance to each subsequent position, and the start position of the main image and increment values which advance to each subsequent position. Each horizontal row of pixels is referred to as a raster line and the data is read from the display data in a raster sequence, one horizontal row after another.

The display is formed by pixels, typically color pixels defined in terms of a color space (a mathematical model for describing a gamut of colors). Pixels may be defined in more than one color space. Color displays generally require that pixels be defined in RGB color space, in which a pixel is described by red, green and blue components. The number of bits per pixel may be a function of the display panel, memory size, and size of the data pathways. For example, 16 bits-per-pixel (16 bpp) may be utilized with 5 bits for red, 6 bits for green, and 5 bits for blue (i.e. RGB 5:6:5). Alternately, 24 bpp may be utilized, i.e. (RGB 8:8:8). Input devices, such as a digital camera, may define pixels in a YUV color space, in which a pixel is described by a brightness component (Y), and two color components (U, V). The YUV model permits the use of a lower resolution for the color information in an image. The human eye is more sensitive to brightness than to color so the use of lower color resolution can conserve processing resources with little visual impact. A lower color resolution may be obtained by means of chroma subsampling, in which a sampling format defines how groups of consecutive YUV pixels are sampled. Particular sampling formats include 4:4:4, 4:2:2, 4:2:0, and 4:1:1. Storing an image with lower color resolution, e.g., in the 4:2:2, 4:2:0, and 4:1:1 sampling formats requires less memory than storing the same image in RGB or YUV 4:4:4 format. For the sake of discussion, it will be assumed that all pixel data is in RGB format. However, it will be understood that data input to the graphics controller may be in YUV format, and that data may be stored in the display buffer 316 in a lower resolution YUV format, and that such data must be converted, for example, by mapping through color conversion look-up-tables (LUTs) prior to being sent to the display 110.

An array of pixels may be referred to as a frame and the display generally displays one frame at a time, although multiple images, e.g. a main image and a border image, may be displayed in the same frame. The data to be displayed is read from the display buffer 316 through display interface 360 and driven by display driver circuitry in display 110 at a given rate, typically set at 60 frames per second, which is chosen based on human visual characteristics and the inability to discern rapid changes in the displayed information. Even if the data in the display buffer 316 is not changed, the frame of pixels in the display 110 must be updated, or “refreshed”, every 1/60^{th} of a second. For example, if the same image is to be displayed for several contiguous frames, then new display data may be written into the display buffer 316 at a rate of only 20-30 frames per second, but it will still be read out of the display buffer 316 at a rate of 60 frames per second in order to refresh the display 110. The display 110, e.g. having an LCD display panel 130, will have a timing control circuit associated with it and that circuit will generate a vertical synchronization signal, Vsync, every 1/60^{th} of a second. The display data for one frame is read from the display buffer 316 in synchronization with the display Vsync, which controls a liquid crystal driver circuit to drive the liquid crystal display panel.

Each time the host processor 102 needs to update the display data, it must write new display data into the main image area of the display. Additionally, if it is desired to change the appearance of the border, new border data must be written into the border area of the display. Assuming that a map of a rectangular portion of the display buffer 316 corresponds to a map of pixel locations in the display panel 130, the host processor 102 writes color display data (e.g. 24 bits-per-pixel, RGB 8:8:8) that defines the appearance of the border into that area of the display buffer 316 allocated to the border.

FIG. 4 shows a memory portion 400 of the display buffer 316 with particular memory locations assigned to the border 214 and particular memory locations assigned to the main image 212, corresponding respectively to border image memory 326 and main image memory 324 of the display buffer 316 (FIG. 3). If it is desired to repeatedly change the appearance of the border over time, the host processor 102 would need to monitor display refresh cycles, e.g. monitor the vertical synchronization signal, Vsync, and write new color display data for each border pixel after each refresh cycle (or after a number of refresh cycles). This requirement places a burden on the host 102 and requires an increase in memory bandwidth due to the increased number of write cycles to memory over bus 104.

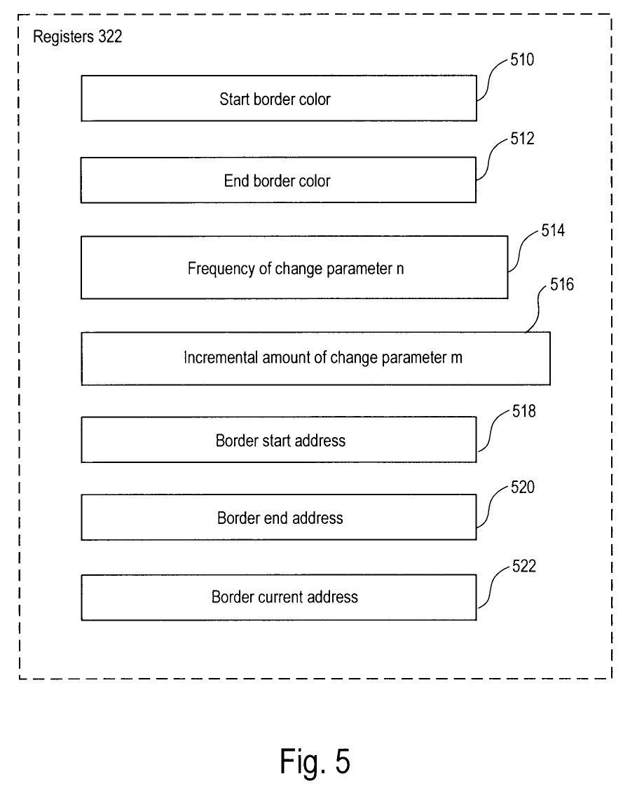

The present invention overcomes this disadvantage by providing a border changing function within the graphics controller. As shown in FIG. 5, registers 322 include a start border color register 510, an end border color register 512, a frequency of change parameter n register 514, an incremental amount of change parameter m register 516, a border start address register 518, a border end address register 520, and a border current address register 522. It will be appreciated that several additional registers will be included in the set of registers 322 but only those pertinent to the present invention will be discussed herein.

In a preferred embodiment, the host processor 102 is programmed by a user to input values into each of registers 510, 512, 514, 516, 518, and 520 via bus 104 and host interface 310. Additionally the host processor 102 activates the border changing circuit 330 with an activation control signal (e.g. ACTIVATE) that is sent via the host interface 310 (FIG. 3)

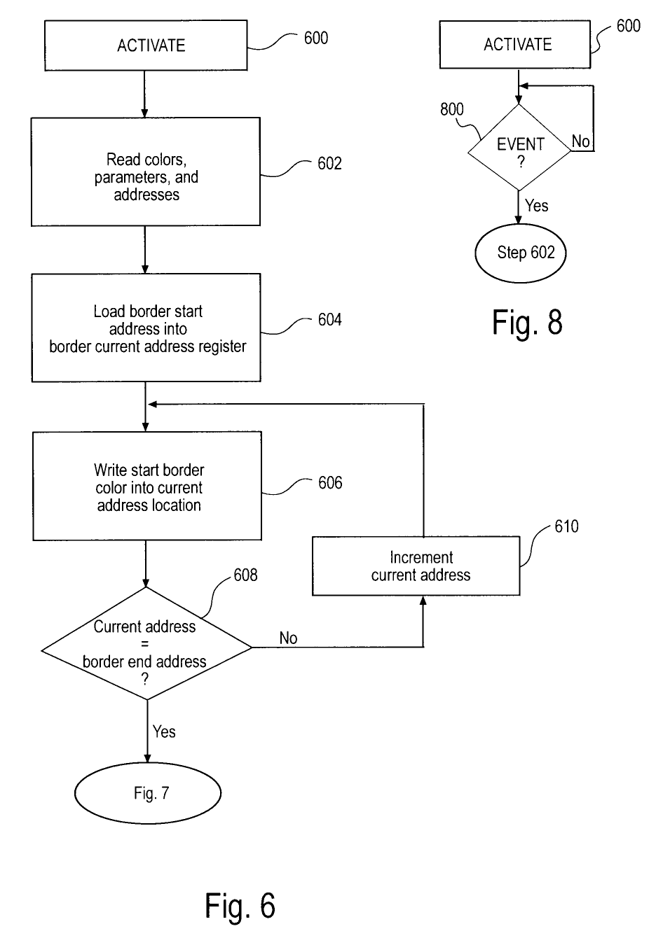

In response to the activation control signal from the host processor 102, the border changing circuit 330 begins operation. FIG. 6 is a flow chart showing exemplary operations performed by border changing circuit 330. Not all steps are necessary to perform the present invention nor is the order of steps necessarily critical, but this flow is exemplary and could be varied by one having ordinary skill in the art to practice the invention. Border changing circuit 330 can take any form that is capable of performing these operations and may include discrete hardware components, ASIC, software, firmware, etc., but is preferably a part of an integrated circuit that comprises the graphics controller, which may be designed using hardware description languages (HDLs) such as industry standards VHDL and Verilog. It will be appreciated that VHDL and Verilog are general-purpose hardware description languages that allow definition of a hardware model at the gate level, the register transfer level or the behavioral level using abstract data types.

Referring to FIG. 6, an activation signal (ACTIVATE) is sent by the host processor 102 on bus 104 and received by the border changing circuit 330 (step 600) via host interface 310. In response, the border changing circuit 330 reads the start border color, end border color, parameter n, parameter m, border start address, and border end address from registers 510, 512, 514, 516, 518, and 520, respectively (step 602). The border changing circuit 330 then writes the start border color into every border pixel location in border image memory 326 (step 606), starting with the border start address (step 604) and ending with the border end address (step 608). The border start address is loaded into the border current address register 522 in step 604. The address in the border current address register 522 is incremented by one, for example, (step 610) until the border end address is reached in step 608. It will be appreciated that the border can take any shape and the border locations on the display panel 130 will not likely be in consecutive raster scan sequence. So, conventional address mapping is required to translate the sequential border addresses into the desired locations on the display panel. This mapping can be performed by the address translation unit as the border color data is written into border image memory 326, or the translation can be performed during refresh as the data is read from memory and sent to the display panel 130. It will be appreciated that in the embodiment shown, the new border color data is written into locations in memory 314. However, the present invention is not so limited and as an alternative, the border color can be changed on the output side of memory 314 such that the original display data in memory 314 is unchanged.

As an example, the start border color is red. Assuming 24 bits-per-pixel, 8 bits per RGB color component, the start border color that is written into every border memory location is 11111111, 00000000, 00000000.

The border changing circuit 330 monitors a timing signal TIMING SIG (FIG. 3). This signal can be for example, Vsync. As described previously, the display 110, e.g. having an LCD display panel 130, will have a timing control circuit associated with it and that circuit will generate a vertical synchronization signal, Vsync, every 1/60^{th} of a second. The display data for one frame is read from the display buffer 316 in synchronization with the display Vsync, which controls a liquid crystal driver circuit to drive the liquid crystal display panel. The graphics controller 100 will monitor the display's vertical synchronization signal, Vsync, which will also be input to the border changing circuit 330 in a preferred embodiment. However, any timing signal can be used such as a timing signal Tm from a crystal oscillator in an internal timing circuit 340.

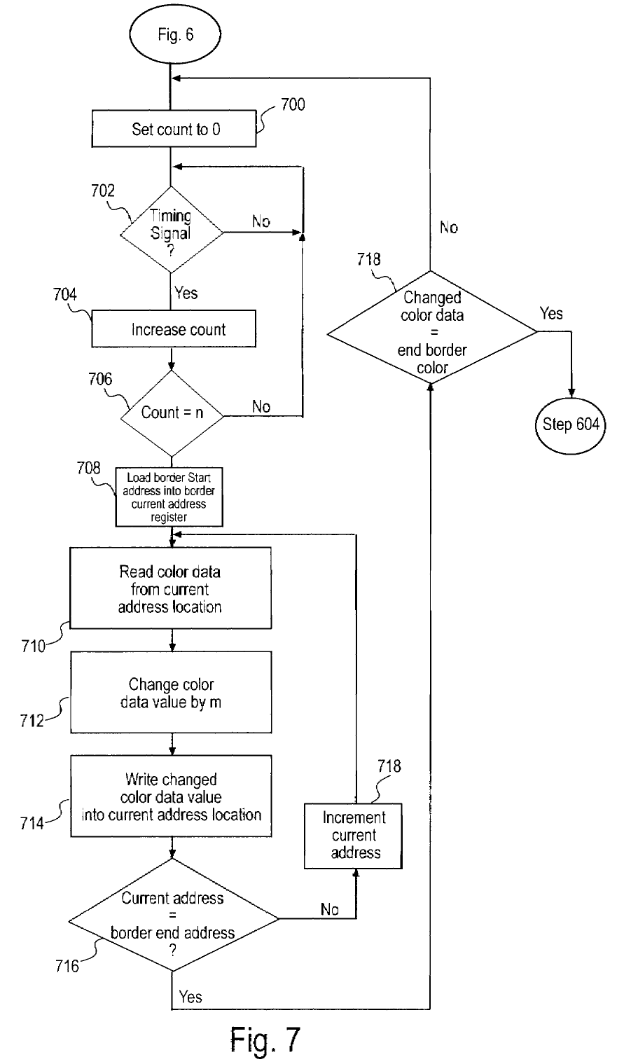

FIG. 7 illustrates the border color changing operation of border changing circuit 330. At step 700, a counter 342 is set to zero. Counter 342 is shown as a separate functional unit in FIG. 3 for illustration purposes but may also be part of border changing circuit 330. At step 702, the border changing circuit 330 checks for a timing signal (TIMING SIG), which may be for example Vsync or Tm, and continues to loop until the timing signal is received. Once the timing signal is received the border changing circuit 330 increases the count value of counter 342 (step 704). It then compares the current count to the frequency of change parameter n (step 706), and continues to loop until the count value equals n. This enables control of the frequency of change of the border color. For example, consider that the timing signal is Vsync, and Vsync is issued every 1/60^{th} of a second. If n is set to 60, then the border color will be changed every second The border with its new color will be read from the display buffer 316 and transmitted to the display in the first frame refresh cycle following the color change.

The border color change operation continues with step 708 in which the border start address is loaded into the border current address register 522. In step 710, the current color data is then read from the location in border image memory 326 identified by the address in the border current address register 522. The current color data is then incremented by m (the incremental amount of change parameter) in step 712. For example, assume the start border color is red (RGB=11111111, 00000000, 000000000) and the end border color is yellow (a mixture of red and green) (RGB=11111111, 11111111, 00000000). If m=1, for example, after the first increase the border color would be RGB=11111111, 00000001, 000000000, and after the second increase the border color would be RGB=11111111, 00000010, 000000000, and so on. To increase the amount of each change, say m=2, for example, after the first increase the border color would be RGB=11111111, 00000010, 000000000, and after the second increase the border color would be RGB=1111111, 00000100, 000000000, and so on. In this example, the incremental amount of change value is added to the green component of the current RGB value in step 712. Of course, it will be appreciated that if the start border color is yellow and the end border color is red (the reverse of the above example), then the incremental amount of change value is subtracted from the green component of the current RGB value in step 712.

In step 714 the changed color data value is written into the address location specified by the border current address register 522. In step 716, the current border address is compared to the border end address. If they are not equal, then the current address is incremented in step 718 and the process moves to step 710 where the current color is read from the next sequential border location. That color is changed, the changed color is written back into the new location and the process continues until all border locations have been updated with the changed color.

Once the current border address equals the border end address at step 716 (i.e. all border locations have be updated with the changed color), the process continues to step 718 to check if the changed color data equals the end border color. If not, the process goes to step 700, which begins the process of changing the border color by the next incremental amount. Once the changed color data equals the end border color (Yes in step 718), the process goes to step 604 in FIG. 6, which starts the process of writing the start border color back into all border locations. Thus, in the example given previously, the border starts out red, progresses over time to yellow, and then goes back to red. This process can be deviated from without departing from the spirit of the invention. Thus, it will be evident to those having ordinary skill in the art that once the border color has reached the end border color, a different start border color can be loaded into the border by, for example, providing subsequent start border color registers, adding a counter that is incremented after step 718 (Yes path) and changing step 606 to load the start border color from one of the subsequent start border color registers as indicated by the counter.

In another embodiment, the border color changing circuit 330 can be activated only upon reception of an event signal (EVENT). For example, a battery monitoring circuit 350 can be provided to monitor the state or condition of a battery 353 and generate an event signal such as BATTlow whenever the voltage of battery 352 falls below a certain threshold level. In response to reception of this signal, the border color changing circuit 330 will begin changing the color as described above with reference to FIGS. 6 and 7. FIG. 8 illustrates the difference in operational flow. At step 800 the border color changing circuit 330 waits for reception of the EVENT signal, such as BATTlow from the a battery monitoring circuit 350. The process will continue to loop (step 800, no) until the EVENT signal is received (step 800, yes) and then progress to step 602 where the process is the same as previously described with reference to FIGS. 6 and 7. In this embodiment, the start border color could be black and end border color red. The frequency of change parameter n and incremental amount of change parameter m will be chosen as a function of typical battery life such that the border gradually changes from black to red as the remaining battery life declines.

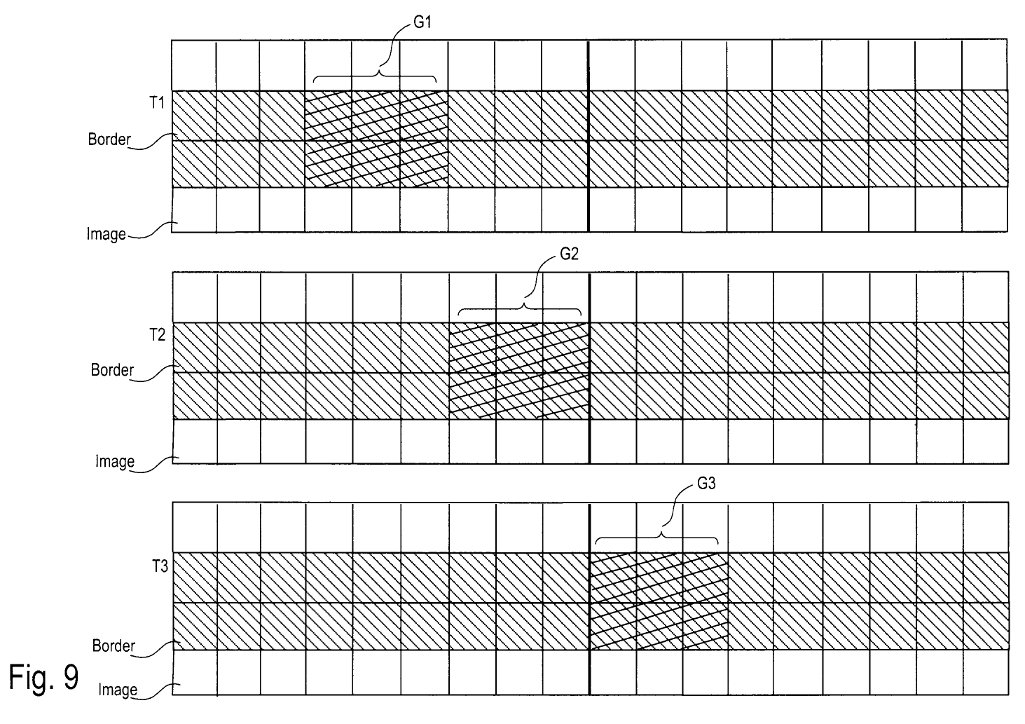

Various other embodiments will become evident to those having ordinary skill in the art. For example, rather that changing the color of the entire border uniformly, distinct groups of pixels in the border can be changed by different amounts. As one example, FIG. 9 shows a portion of a two color border at times n=T1, T2, and T3. The color values of a first group G1 of 6 pixels are changed at T1 to a dark value. At T2, the color values of the first group of pixels G1 are changed to a light value and a second group G2 of 6 pixels is changed to the dark value. Similarly, at T3, the second group G2 of 6 pixels is changed to the light value and a third group G3 of 6 pixels is changed to the dark value. This embodiment creates the appearance of a rectangular object moving from left to right in the border. When the entire border is viewed, the object appears to run laps around the border.

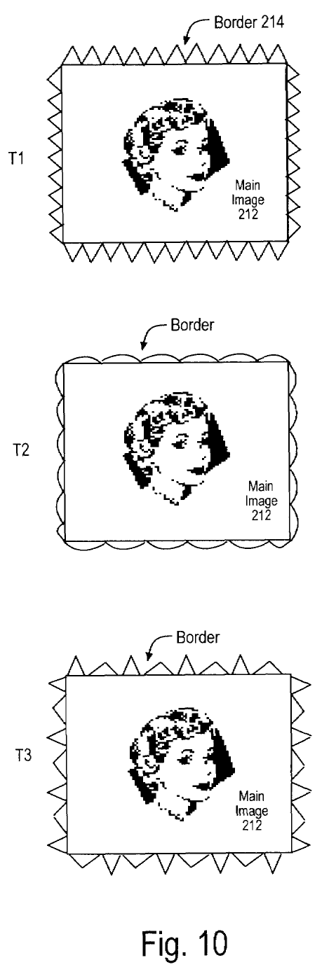

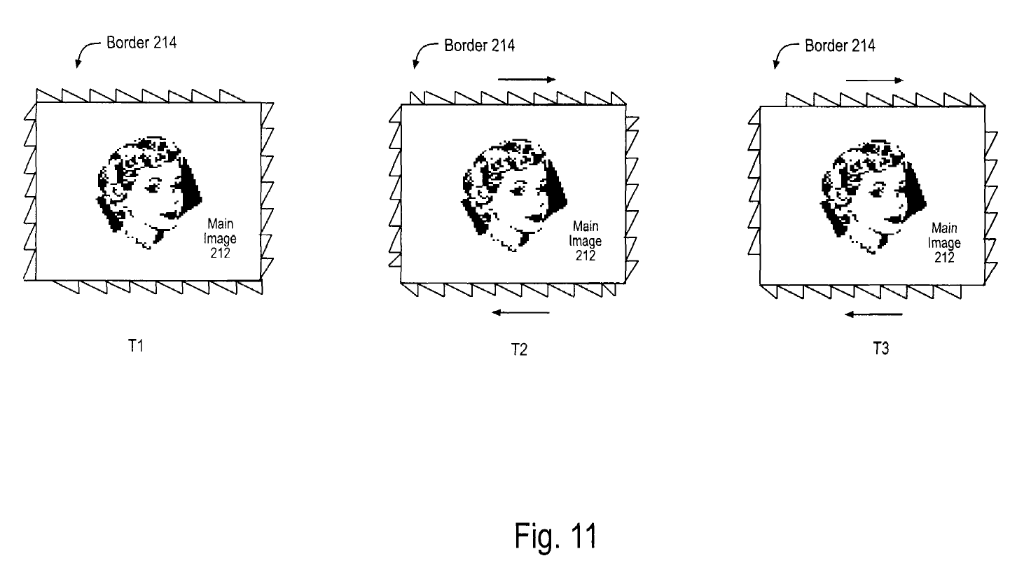

As another embodiment, rather than changing the color of the border over time, the shape of the border can be changed over time. Commonly assigned U.S. Patent Application Publication No. 2005/0185852 describes a method and apparatus for generating complex borders in a graphics controller without host processor intervention, which published patent application is incorporated herein by reference in its entirety. Utilizing the principles of the present invention described above, a different shape can be applied to the border over time. For example, FIG. 10 shows several exemplary shapes for borders 214, which could be mapped to a table as described in Application Publication No. 2005/0185852 and accessed/generated at different time periods T1, T2, T3. As another example, FIG. 11 shows a border in which the general shape remains the same but the border image is varied over time by shifting the shape relative to the main image to give the appearance of the border moving clockwise around the image.

The invention can also be embodied as computer readable code stored on a computer readable medium. The computer readable medium is any data storage device that can store data which can be thereafter read and executed by a computer. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

We claim:

1. A method for changing over time the appearance of a border around a displayed image, comprising:
writing one or more border addresses and one or more border changing parameters into a graphics controller from a host device;
activating a border appearance changing operation in the graphics controller,
generating a timing signal,
changing the appearance of the border over time in response to the timing signal by utilizing the one or more border addresses and the one or more border changing parameters.

2. The method of claim 1, wherein the one or more border changing parameters is a frequency of change parameter.

3. The method of claim 1, wherein the one or more border changing parameters is an incremental amount of change parameter.

4. The method of claim 1, further comprising:
generating an event signal and wherein the step of changing the appearance of the border occurs in response to generation of the event signal.

5. The method of claim 4, wherein the generation of the event signal is in response to a monitored state of a battery

6. The method of claim 1, wherein the timing signal is a display synchronization signal.

7. The method of claim 1, wherein the one or more border changing parameters is a start border color or an end border color.

8. The method of claim 1, wherein the one or more border addresses is a border start address or a border end address.

9. A graphics controller that provides an interface between a host device and a display device, and that changes over time the appearance of a border around a displayed image, comprising:
one or more border address registers that each store a border address received from the host device;
one or more border changing parameter registers that each store a border changing parameter received from the host device; and
a border changing circuit that is responsive to a timing signal to change the appearance of the border over time in accordance at least one border address stored in the one or more border address registers and at least one border changing parameter stored in the one or more border changing parameter registers.

10. The graphics controller of claim 9, wherein a border changing parameter is a frequency of change parameter.

11. The graphics controller of claim 10 further comprising a counter that counts each occurrence of the timing signal and the border changing circuit being responsive to the count equaling the frequency of change parameter to change the appearance of the border.

12. The graphics controller of claim 9 wherein a border changing parameter is an incremental amount of change parameter.

13. The graphics controller of claim 12 wherein the border changing circuit is responsive to the incremental amount of change parameter for changing the appearance of the border by an amount specified by the incremental amount of change parameter.

14. The graphics controller of claim 9 wherein the timing signal is a display synchronization signal received from the display device.

15. The graphics controller of claim 9 wherein the border changing circuit changes the color of the border over time.

16. The graphics controller of claim 9 wherein the border changing circuit changes the shape of the border over time.

17. A display system that changes over time the appearance of a border around a displayed image, comprising:
a host device;
a display device; and
a graphics controller that provides an interface between the host device and the display device, and that changes over time the appearance of the border around the displayed image, comprising:
one or more border address registers that each store a border address received from the host device;
one or more border changing parameter registers that each store a border changing parameter received from the host device; and
a border changing circuit that is responsive to a timing signal to change the appearance of the border over time in accordance at least one border address stored in the one or more border address registers and at least one border changing parameter stored in the one or more border changing parameter registers.

18. The display system of claim 17, further comprising an event signal generator and wherein the border changing circuit is responsive to generation of the event signal for changing the appearance of the border.

19. The display system of claim 18, wherein the event signal generator is a battery monitoring circuit.

20. The display system of claim 17, wherein the timing signal is a display synchronization signal received by the graphics controller from the display device.
